(19) United States
(12) Patent Application Publication
(10) Pub. No.: US 2021/0241148 A1
(43) Pub. Date: Aug. 5, 2021

(54) ABDUCTION APPARATUS, ABDUCTION METHOD, AND COMPUTER-READABLE RECORDING MEDIUM

(71) Applicant: NEC Corporation, Minato-ku, Tokyo (JP)

(72) Inventor: Kazeto YAMAMOTO, Tokyo (JP)

(73) Assignee: NEC Corporation, Minato-ku, Tokyo (JP)

(21) Appl. No.: 17/269,333

(22) PCT Filed: Aug. 27, 2018
(86) PCT No.: PCT/JP2018/031623

§ 371 Date: Feb. 18, 2021

(51) Int. Cl. G06N 5/04; G06N 5/02; G06K 9/62; G06N 7/00

(52) U.S. Cl. CPC G06N 5/041; G06N 7/005; G06K 9/6277; G06N 5/022

(57) ABSTRACT

An abduction apparatus 1 includes: a posterior probability calculation unit 2 that calculates, a posterior probability regarding the observation information D1 with respect to each of candidate hypotheses D3 generated using observation information D1 and knowledge information D2; a deduction probability calculation unit 3 that calculates, a deduction probability of deriving observation information D1 as a consequence of applying the knowledge information with respect to each of the candidate hypotheses; a consistency probability calculation unit 4 that calculates, a consistency probability of not contradicting the knowledge information D2 with respect to each of the candidate hypotheses; and a solution hypothesis determination unit 5 that calculates an evaluation value using the posterior probability, the deduction probability, and the consistency probability, and determines a solution hypothesis D4 that is a best explanation regarding the observation information D1, from the candidate hypotheses, based on the calculated evaluation value.

### TECHNICAL FIELD

The present invention relates to an abduction apparatus and an abduction method for executing abduction, and further relates to a computer-readable recording medium that includes a program for realizing the same recorded thereon.

### BACKGROUND ART

According to known abduction processing, first, a set of candidate hypotheses is generated using a query logical formula and background knowledge. The query logical formula is a conjunction of first-order predicate logic literals. The first-order predicate logic literal is an atomic formula in a first-order predicate logic, or a negation of the atomic formula. The background knowledge is a set of inference rules. The inference rules are implication logical formulae.

Next, in such abduction processing, each candidate hypothesis of the generated set is evaluated. Then, a most appropriate candidate hypothesis (solution hypothesis) is selected, from the set of candidate hypotheses, as an explanation regarding the query logical formula based on the evaluations regarding the candidate hypotheses.

Also, in probabilistic abduction, out of the abduction processing, each inference rule included in the background knowledge is given a parameter indicating “the degree of probability that the inference rule backwardly holds true”. In the evaluation of the candidate hypothesis, a posterior probability of a candidate hypothesis regarding the query logical formula is calculated as the evaluation value.

As a related technique, probabilistic abduction is disclosed in Non-Patent Document 1. According to Non-Patent Document 1, a framework of probabilistic abduction using Cost-based Probabilistic Abduction is proposed.

### LIST OF RELATED ART DOCUMENTS

### Non-Patent Document

Non-Patent Document 1: Eugene Charniak, Solomon E. Shimony, “Probabilistic Semantics for Cost-Based Abduction” Brown University, Providence, R.I., 1990.

### SUMMARY

### Technical Problems

However, in the probabilistic abduction as described above, a framework in which an uncertain inference rule can be handled is not present. Here, the uncertain inference rule indicates an inference rule that does not certainly hold true such as “if a subject is a bird, the subject flies”, for example.

That is, heretofore, there is an assumption that all of the inference rules are axioms (necessarily true), and therefore, if an uncertain inference rule is included in the background knowledge, the hypothesis cannot be correctly evaluated.

An example object of the present invention is to provide an abduction apparatus and an abduction method that can handle an uncertain inference rule, and a computer-readable recording medium.

### Solution to the Problems

To achieve the above-stated example object, an abduction apparatus according to an example aspect of the present invention includes:

a posterior probability calculation unit configured to calculate, a posterior probability regarding the observation information with respect to each of candidate hypotheses generated using observation information and knowledge information;

a deduction probability calculation unit configured to calculate, a deduction probability of deriving observation information as a consequence of applying the knowledge information with respect to each of the candidate hypotheses;

a consistency probability calculation unit configured to calculate, a consistency probability of not contradicting the knowledge information with respect to each of the candidate hypotheses; and

a solution hypothesis determination unit configured to calculate an evaluation value using the posterior probability, the deduction probability, and the consistency probability, and determine a solution hypothesis that is a best explanation regarding the observation information, from the candidate hypotheses, based on the calculated evaluation value.

Also, to achieve the above-stated example object, an abduction method according to an example aspect of the present invention includes:

(a) a step of calculating, a posterior probability regarding the observation information with respect to each of candidate hypotheses generated using observation information and knowledge information;

(b) a step of calculating, a deduction probability of deriving observation information as a consequence of applying the knowledge information with respect to each of the candidate hypotheses;

(c) a step of calculating, a consistency probability of not contradicting the knowledge information with respect to each of the candidate hypotheses; and

(d) a step of calculating an evaluation value using the posterior probability, the deduction probability, and the consistency probability, and determining a solution hypothesis that is a best explanation regarding the observation information, from the candidate hypotheses, based on the calculated evaluation value.

Furthermore, to achieve the above-stated example object, a computer-readable recording medium according to an example aspect of the present invention is a computer-readable recording medium that includes a program recorded thereon, the program causing the computer to carry out:

(a) a step of calculating, a posterior probability regarding the observation information with respect to each of candidate hypotheses generated using observation information and knowledge information;

(b) a step of calculating, a deduction probability of deriving observation information as a consequence of applying the knowledge information with respect to each of the candidate hypotheses;

(c) a step of calculating, a consistency probability of not contradicting the knowledge information with respect to each of the candidate hypotheses; and

(d) a step of calculating an evaluation value using the posterior probability, the deduction probability, and the consistency probability, and determining a solution hypothesis that is a best explanation regarding the observation information, from the candidate hypotheses, based on the calculated evaluation value.

### Advantageous Effects of the Invention

As described above, according to the present invention, an uncertain inference rule can be handled.

### BRIEF DESCRIPTION OF THE DRAWINGS

FIG. 1 is a diagram illustrating an example of an abduction apparatus.

FIG. 2 is a diagram illustrating an example of a system including the abduction apparatus.

FIG. 3 is a diagram illustrating an example of a candidate hypothesis generation unit.

FIG. 4 is a diagram illustrating an example of operations of the abduction apparatus.

FIG. 5 is a diagram illustrating an example of a query logical formula and background knowledge.

FIG. 6 is a diagram illustrating an example of a candidate hypothesis.

FIG. 7 is a diagram illustrating an example of a data structure of the candidate hypothesis.

FIG. 8 is a diagram illustrating an example of a computer that realizes the abduction apparatus.

### EXAMPLE EMBODIMENT

### Example Embodiment

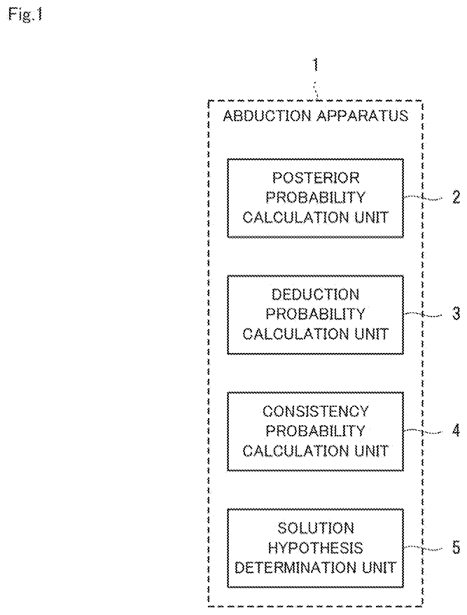

Hereinafter, an example embodiment of the present invention will be described with reference to FIGS. 1 to 8.

[Apparatus Configuration]

First, the configuration of an abduction apparatus 1 according to the present example embodiment will be described using FIG. 1. FIG. 1 is a diagram illustrating an example of the abduction apparatus.

The abduction apparatus 1 shown in FIG. 1 is an apparatus that can handle an uncertain inference rule. As shown in FIG. 1, the abduction apparatus 1 includes a posterior probability calculation unit 2, a deduction probability calculation unit 3, a consistency probability calculation unit 4, and a solution hypothesis determination unit 5.

Among these units, the posterior probability calculation unit 2 calculates a posterior probability regarding observation information with respect to each of candidate hypotheses that have been generated using observation information (query logical formula) and knowledge information (background knowledge). The deduction probability calculation unit 3 calculates a deduction probability that the observation information can be derived as a consequence of applying the knowledge information, with respect to each of the candidate hypotheses. The consistency probability calculation unit 4 calculates a consistency probability of not contradicting the knowledge information, with respect to each of the candidate hypotheses.

The solution hypothesis determination unit 5 calculates an evaluation value using the posterior probability, the deduction probability, and the consistency probability, and determines a solution hypothesis that is the best explanation with respect to the observation information, out of the candidate hypotheses, based on the calculated evaluation value.

As described above, according to the present example embodiment, the solution hypothesis is determined out of the candidate hypotheses based on the posterior probability, the deduction probability, and the consistency probability, and therefore an uncertain inference rule can be handled.

[System Configuration]

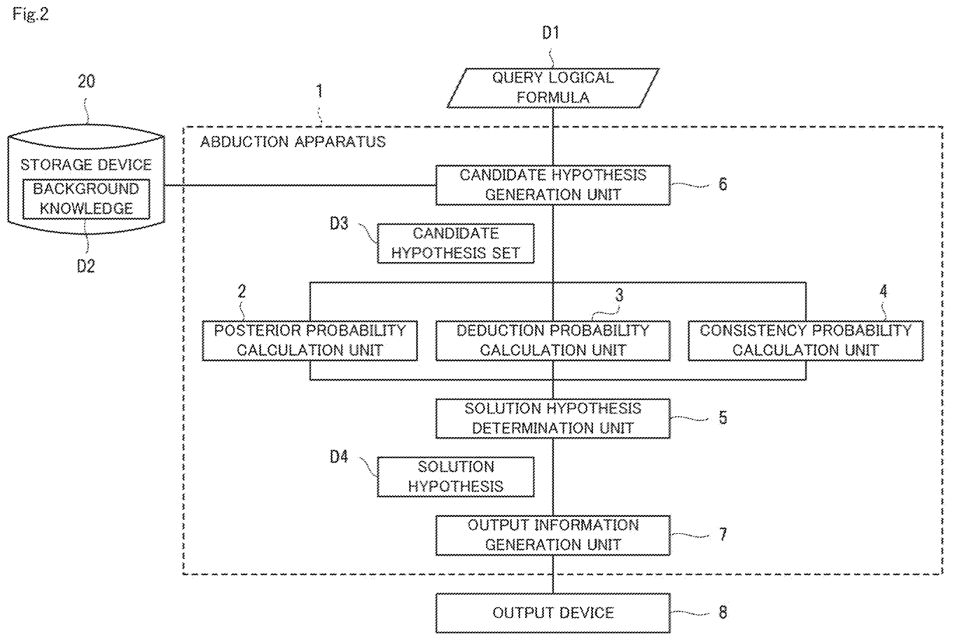

Next, the configuration of the abduction apparatus 1 according to the present example embodiment will be more specifically described using FIG. 2. FIG. 2 is a diagram illustrating an example of a system including the abduction apparatus.

As shown in FIG. 2, the abduction apparatus 1 according to the present example embodiment includes a candidate hypothesis generation unit 6, and a output information generation unit 7, in addition to the posterior probability calculation unit 2, the deduction probability calculation unit 3, the consistency probability calculation unit 4, and the solution hypothesis determination unit 5. Also, the system including the abduction apparatus 1 includes an output device 8, and a storage device 20. The storage device 20 may be provided inside of the abduction apparatus 1, or may be provided outside thereof.

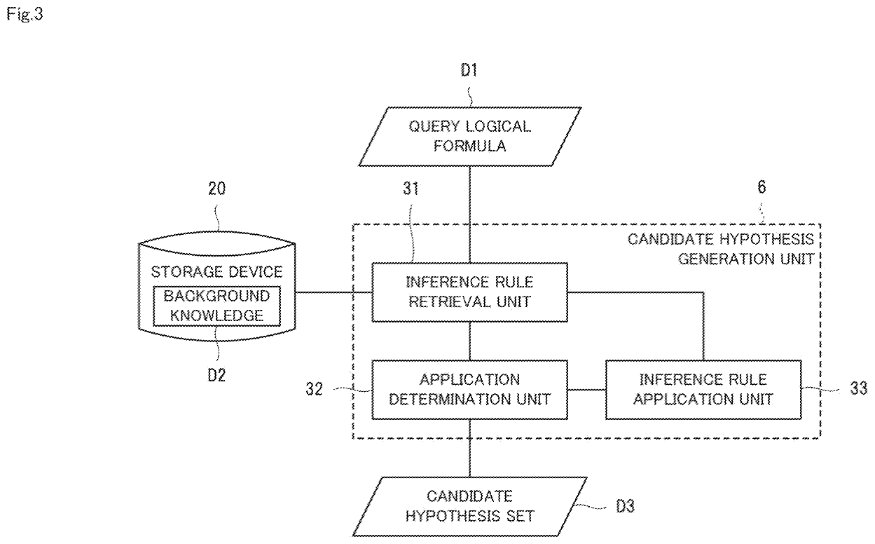

The candidate hypothesis generation unit 6 acquires a query logical formula D1 and background knowledge D2 that is stored in the storage device 20, and generates a candidate hypothesis set D3 including a plurality of candidate hypotheses using processing for generating candidate hypotheses. Also, the candidate hypothesis generation unit 6 includes an inference rule retrieval unit 31, an application determination unit 32, and an inference rule application unit 33, as shown in FIG. 3. FIG. 3 is a diagram illustrating an example of the candidate hypothesis generation unit.

The query logical formula D1 is a conjunction of first-order predicate logic literals. The first-order predicate logic literal is an atomic formula or a negation thereof in the first-order predicate logic.

The background knowledge D2 is a set of inference rules. The inference rule is an implication logical formula, and is expressed by a logical formula in a form shown in formula (1).

[Math. 1]

P₁ΛP₂Λ . . . ΛP_{N}⇒Q₁ΛQ₂Λ . . . ΛQ_{M} (1)
Pᵢ, Qⱼ: first-order predicate logic literal

Note that it is assumed that the variables included in the antecedents in the inference rules are all universally quantified, and the variables included in only the consequents of the inference rules are all existentially quantified. Hereinafter, even in a case where the quantifier is omitted, each variable is quantified based on the assumption described above.

Also, it is assumed that a case where the antecedent is empty, that is, N=0 in formula (1) is allowed, and such a rule is called a fact, which indicates that the consequent unconditionally holds true. In the following, the antecedent and implication symbol will be omitted regarding a fact, and the fact is simply expressed by a logical formula in a form of formula (2).

[Math. 2]

Q₁ΛQ₂Λ . . . ΛQ_{M} (2)

Also, an inference rule in which the consequent is false is allowed. Moreover, each inference rule is given parameters that are needed in the probability calculation to be performed in the posterior probability calculation unit 2, the deduction probability calculation unit 3, and the consistency probability calculation unit 4. What types of parameters are given are determined based on the model that is adopted in each of the posterior probability calculation unit 2, the deduction probability calculation unit 3, and the consistency probability calculation unit 4. Specifically, an inference rule is given a probability (refer to formula (3)) that the inference rule holds true backwardly, and a probability (refer to formula (4)) that the inference rule holds true forwardly, for example.

[Math. 3]

p(Λᵢ₌₁^{N}Pᵢ|Λⱼ₌₁^{M}Qⱼ) (3)

[Math. 4]

p(Λᵢ₌₁^{M}Qᵢ|Λⱼ₌₁^{N}Pⱼ) (4)

Note that, with respect to an inference rule in which the fact and the consequent are false, because the inference rule will not be used in backward inference, the probability of holding true backwardly is not needed.

The candidate hypothesis set D3 is a set of candidate hypotheses that is output from the candidate hypothesis generation unit 6. The candidate hypothesis is a directed non-cycling hypergraph in which first-order predicate logic literals are nodes, and an edge that connects hypernodes expresses a relationship “which literal is explained by which literal using which inference rule”. The terminal node that is reached by tracing back edges matches one of the first-order predicate logic literals included in the query logical formula D1. Also, the first-order predicate logic literal corresponding to an unexplained node, that is, a node that is not included in any end points of edges is called an element hypothesis logical formula.

The inference rule retrieval unit 31 performs processing in which an inference rule is retrieved that can be applied backwardly with respect to the current candidate hypothesis set D3. Specifically, the inference rule retrieval unit 31 retrieves an inference rule in which a manner of variable substitution is present so as to be equivalent with the conjunction of the first-order predicate logic literals included in the candidate hypothesis, with respect to the first-order predicate logic literals included in the consequent of the inference rule. For example, with respect to a candidate hypothesis q(A), an inference rule p(x)⇒q(x) is backwardly applicable, and an inference rule p(x)⇒r(x) is not backwardly applicable.

The application determination unit 32 performs end determination of processing for generating a candidate hypothesis. Specifically, if an inference rule that can be newly applied to the current candidate hypothesis set is not present, the application determination unit 32 ends the processing of the candidate hypothesis generation unit, and outputs the candidate hypotheses that have been generated until this point in time.

The inference rule application unit 33 performs processing for generating a new candidate hypothesis by applying the inference rule retrieved by the inference rule retrieval unit 31 to the candidate hypothesis set D3. Specifically, the inference rule application unit 33 generates a new candidate hypothesis q(A)Λp (A) by applying the inference rule p(x)⇒q(x) to the candidate hypothesis q(A).

Note that the candidate hypothesis generation unit 6 may generate the candidate hypothesis set D3 using the processing shown in FIG. 3, or may also generate the candidate hypothesis set D3 using another method.

The posterior probability calculation unit 2 acquires candidate hypotheses from the candidate hypothesis set D3, and calculates a posterior probability (refer to formula (5)) regarding the query logical formula D1, with respect to each of the candidate hypotheses. Specifically, the posterior probability calculation unit 2 calculates, assuming that the true probabilities of the inference rules are independent, a joint probability that the inference rules used in the process of backwardly deriving an element hypothesis logical formula from the query logical formula D1 hold true backwardly.

[Math. 5]

Posterior probability: P(H|O) (5)

The deduction probability calculation unit 3 acquires candidate hypotheses from the candidate hypothesis set D3, and calculates a deduction probability (refer to formula (6)) that the query logical formula D1 can be derived as a consequence of applying the background knowledge D2, with respect to each of the candidate hypotheses. Specifically, the deduction probability calculation unit 3 calculates, assuming that true probabilities of the respective inference rules are independent, a joint probability that the inference rules that are respectively used in the candidate hypotheses hold true forwardly.

[Math. 6]

Deduction probability: P(H∪B [symbol] 0) (6)

The consistency probability calculation unit 4 acquires candidate hypotheses from the candidate hypothesis set D3, and calculates, with respect to each of the candidate hypotheses, a consistency probability (refer to formula (7)) that the candidate hypothesis does not contradict the background knowledge D2. Specifically, the consistency probability calculation unit 4, assuming that the true probabilities of the respective rules are independent, enumerates inference rules that contradict the respective candidate hypotheses, and calculates a joint probability that these rules do not hold true forwardly.

[Math. 7]

Consistency probability: P(H∪B [symbol] ⊥) (7)

The solution hypothesis determination unit 5 determines, from the candidate hypothesis set D3 regarding which the posterior probability, the deduction probability, and the consistency probability were calculated, a candidate hypothesis regarding which the probability that the candidate hypothesis holds true as the explanation of the query logical formula D1, that is, the joint probability of the aforementioned three probabilities is largest. Specifically, the solution hypothesis determination unit 5 calculates an evaluation value (refer to formula (8)) by multiplying the posterior probability, the deduction probability, and the consistency probability, and determines a candidate hypothesis, out of the candidate hypotheses included in the candidate hypothesis set D3, regarding which the evaluation value is largest as a solution hypothesis D4. Therefore, the solution hypothesis D4 is the candidate hypothesis, out of the candidate hypotheses included in the candidate hypothesis set D3, regarding which the probability of holding true as the explanation of the query logical formula is largest.

[Math. 8]

Joint probability: P(H|O)P(H∪B [symbol] O)P(H∪B [symbol] ⊥) (8)

Note that the solution hypothesis determination unit 5 may, similarly to a conventional method, perform formulation as some combinatorial optimization problem such as an integer linear planning problem or a weighted satisfiability problem, and obtain the solution hypothesis by retrieving an optimum solution using a corresponding solver.

The output information generation unit 7 acquires a candidate hypothesis, a posterior probability, a deduction probability, and a consistency probability, and generates output information in which the posterior probability, the deduction probability, and the consistency probability are given to the candidate hypothesis, and that is to be output to the output device 8. Alternatively, the output information generation unit 7 generates proof tree information for outputting a proof tree structure to the output device 8 using the query logical formula D1, the candidate hypothesis, the posterior probability, the deduction probability, the consistency probability, and the solution hypothesis D4. Moreover, the output information generation unit 7 may generate both of the output information and the proof tree information. Thereafter, the output information generation unit 7 transmits the generated output information, or proof tree information, or both pieces of the information to the output device 8.

The output device 8 receives the output information or proof tree information that has been converted to an outputtable format, or both pieces of the information from the output information generation unit 7, and outputs an image, a sound, and the like that are generated based on the output information or the proof tree information, or both pieces of the information. The output device 8 includes an image display device using liquid crystal, organic EL (Electro Luminescence), or a CRT (Cathode Ray Tube), and furthermore, a sound output device such as a speaker, for example. Note that the output device 8 may also be a printing device such as a printer.

[Apparatus Operations]

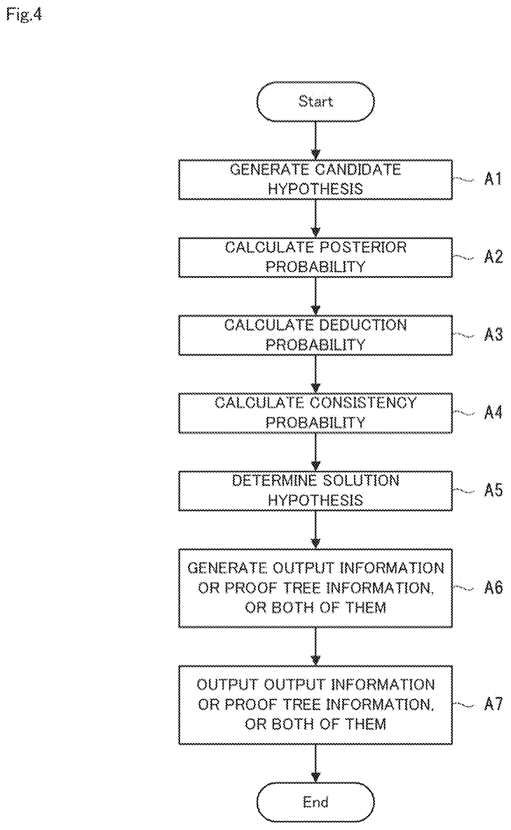

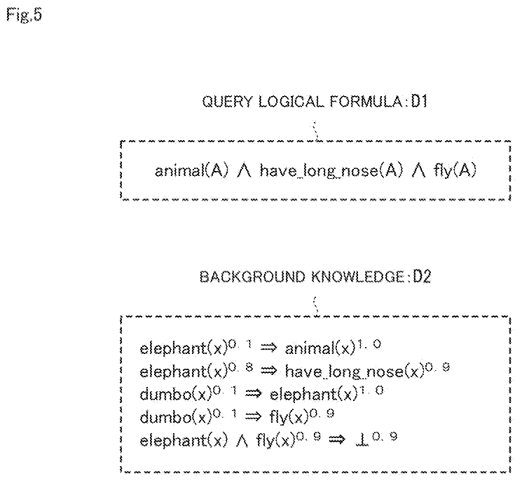

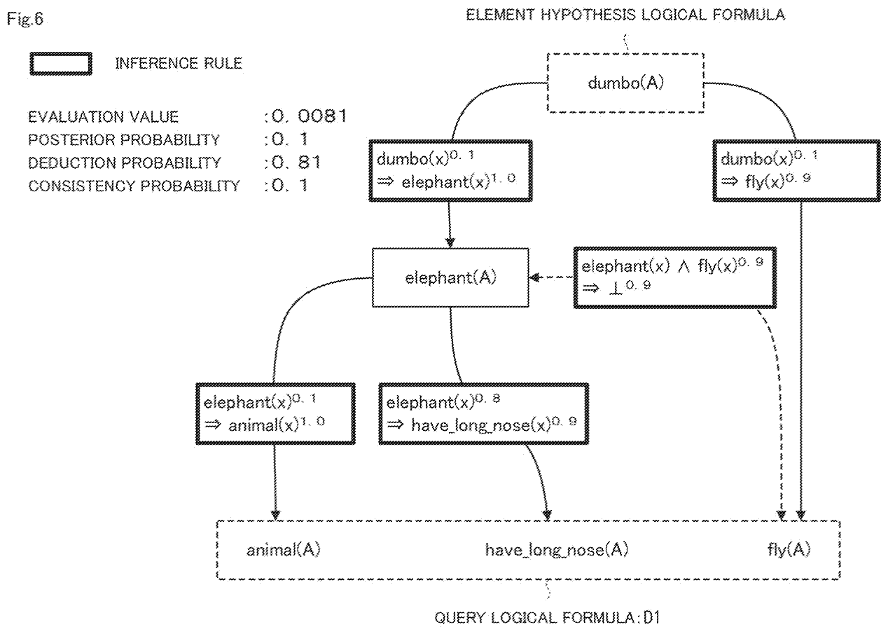

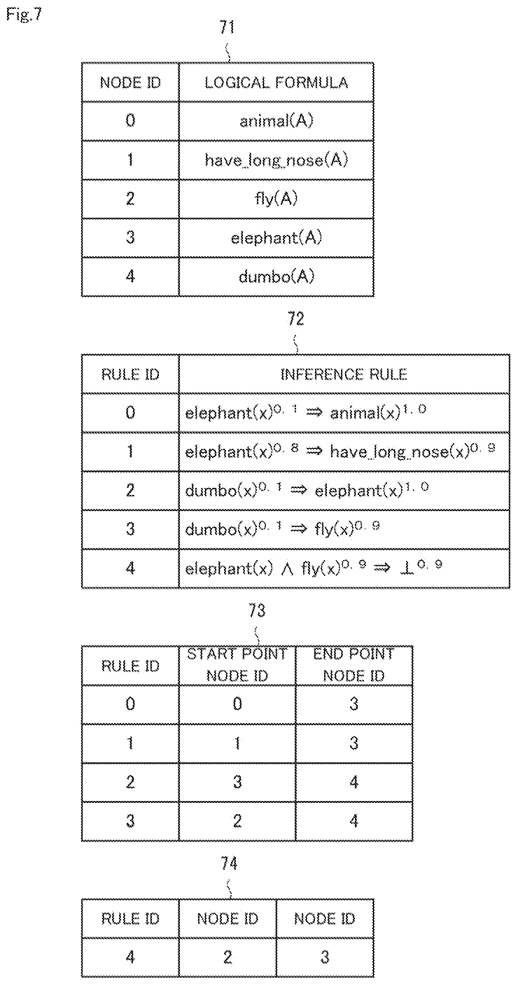

Next, the operations of the abduction apparatus 1 according to the example embodiment of the present invention will be described using FIGS. 4, 5, 6 and 7. FIG. 4 is a diagram illustrating an example of the operations of the abduction apparatus. FIG. 5 is a diagram illustrating an example of the query logical formula and the background knowledge. FIG. 6 is a diagram illustrating an example of the candidate hypothesis. FIG. 7 is a diagram illustrating an example of the data structure of the candidate hypothesis. Also, in the following description, FIGS. 2 to 7 will be referred to as appropriate. In the following description, FIGS. 2 to 7 will be referred to as appropriate. Furthermore, in the present example embodiment, the abduction method is carried out by causing the abduction apparatus 1 to operate. Therefore, the following description of the operations of the abduction apparatus 1 applies to the abduction method according to the present example embodiment.

As shown in FIG. 4, first, the candidate hypothesis generation unit 6 acquires the query logical formula D1 and the background knowledge D2, and generates a candidate hypothesis set D3 including a plurality of candidate hypotheses (step A1).

Next, the posterior probability calculation unit 2 acquires candidate hypotheses from the candidate hypothesis set D3, and calculates a posterior probability (refer to formula (5)) regarding the query logical formula D1, with respect to each of the candidate hypotheses (step A2). The deduction probability calculation unit 3 acquires candidate hypotheses from the candidate hypothesis set D3, and calculates a deduction probability (refer to formula (6)) that the query logical formula can be derived as a consequence of applying the background knowledge D2, with respect to each of the candidate hypotheses (step A3). The consistency probability calculation unit 4 acquires candidate hypotheses from the candidate hypothesis set D3, and calculates a consistency probability (refer to formula (7)) of not contradicting the background knowledge D2, with respect to each of the candidate hypotheses (step A4). Note that the order of processing in steps A2 to A4 is not specifically limited. Also, the processing in steps A2 to A4 may be executed at the same time.

Next, the solution hypothesis determination unit 5, calculates, with respect to each of the candidate hypotheses included in the candidate hypothesis set D3, an evaluation value (refer to formula (8)) by multiplying the posterior probability, the deduction probability, and the consistency probability, and determines a candidate hypothesis regarding which the evaluation value is largest as the solution hypothesis D4 (step A5).

Next, the output information generation unit 7 acquires the candidate hypothesis, the posterior probability, the deduction probability, and the consistency probability, and generates output information that is to be output to the output device 8 and in which the posterior probability, the deduction probability, and the consistency probability are added to the candidate hypothesis (step A6). Alternatively, the output information generation unit 7 generates proof tree information for outputting a proof tree structure to the output device 8 using the query logical formula D1, the candidate hypothesis, the posterior probability, the deduction probability, the consistency probability, and the solution hypothesis D4. Moreover, the output information generation unit 7 may generate both of the output information and the proof tree information.

The output device 8 receives the output information or proof tree information that has been converted to an outputtable format, or both pieces of the information from the output information generation unit 7, and outputs an image, a sound, and the like that are generated based on the output information or the proof tree information, or both pieces of the information (step A7).

Next, the operations of the abduction apparatus 1 will be described more specifically.

The query logical formula D1 is assumed to be a conjunction that logically expresses a target state that “an animal having a long nose is flying”. Refer to the query logical formula D1 shown in FIG. 5.

The background knowledge D2 gives, a logical formula that expresses observation information that “an animal having a long nose is flying” being the query logical formula D1, inference rules that expresses, in logical expressions, knowledges “if x is an elephant, then x is an animal”, “if x is an elephant, then x has a long nose”, “if x is Dumbo, then x is an elephant”, “if x is Dumbo, then x flies”, and “x is an elephant, and x does not fly”. Refer to the background knowledge D2 shown in FIG. 5.

Also, the actual values given to the antecedent and consequent of each inference rule of the background knowledge D2 indicates the probability that the inference rule holds true backwardly and forwardly. For example, in the case of first row in the background knowledge D2 in FIG. 5, “animal(x)^{0.1}” expresses that if “animal(x)” holds true, then “elephant(x)” holds true with a probability 0.1.

In step A1, the candidate hypothesis generation unit 6 generates the candidate hypothesis set D3 from the query logical formula D1 and the background knowledge D2. Note that the initial state of the candidate hypothesis set D3 includes only a candidate hypothesis including only the query logical formula D1.

Specifically, in step A1, first, the inference rule retrieval unit 31 of the candidate hypothesis generation unit 6 retrieves an inference rule that can be applied to the candidate hypothesis set D3 backwardly, from the background knowledge D2. For example, with respect to an inference rule “elephant(x)⇒animal(x)”, as a result of substituting “x=A”, the consequent of the inference rule matches a portion of the candidate hypothesis, and therefore this inference rule is selected as being applicable backwardly.

Next, in step A1, the inference rule selected by the inference rule retrieval unit 31 is applied to the candidate hypothesis set backwardly, in the inference rule application unit 33. For example, if the inference rule “elephant(x)⇒animal(x)” is applied to the initial state of the candidate hypothesis set D3 described above, a new candidate hypothesis “animal(A)Λhave_long_nose(A)Λfly(A)Λelephant(A)” is added to the candidate hypothesis set.

The candidate hypothesis set D3, finally, includes candidate hypotheses of the number corresponding to the combination of applicabilities of respective inference rules. For example, if all of the inference rules are applied, the candidate hypothesis as shown in FIG. 6 is obtained. Also, if the inference rules are not applied, the candidate hypothesis includes only the query logical formula.

Next, in step A2, the posterior probability calculation unit 2 acquires the candidate hypothesis set D3, and calculates a posterior probability regarding the query logical formula D1, with respect to each of the candidate hypotheses. Specifically, in step A2, the posterior probability calculation unit 2 calculates a joint probability that an element hypothesis logical formula included in the candidate hypothesis is derived from the query logical formula.

For example, in the candidate hypothesis shown in FIG. 6, only one element hypothesis logical formula “dumbo(A)” is present, and therefore the probability desired to be obtained is a posterior probability of “dumbo(A)” with respect to the query logical formula. Here, a plurality of paths for deriving “dumbo(A)” from the query logical formula are conceivable, and the path regarding which the probability is highest is adopted.

In the example in FIG. 6, if it is assumed that “dumbo(A)” is hypothesized using “fly(A)” of the query logical formula as a reason, because the posterior probability is a probability that “dumbo(A)” is derived from “fly(A)”, the posterior probability is 0.1, from the backward probability of the inference rule.

Next, in step A3, the deduction probability calculation unit 3 acquires the candidate hypothesis set D3, and calculates the probability that the query logical formula D1 is derived as a consequence, by applying the background knowledge D2 to each of the candidate hypotheses. Specifically, the deduction probability calculation unit 3 calculates a joint probability that all of the inference rules used in the candidate hypotheses hold true forwardly.

For example, the inference rules used in the candidate hypotheses shown in FIG. 6 correspond to four solid line arrows. The probability that these candidate hypotheses derive the query logical formula D1 as a consequence can be calculated as the joint probability that these four inference rules hold true forwardly. Refer to formula (9).

1.0×1.0×0.9×0.9=0.81 (9)

Next, in step A4, the consistency probability calculation unit 4 acquires the candidate hypothesis set D3, and calculates, with respect to each of the candidate hypotheses, a probability that the candidate hypothesis does not contradict the background knowledge D2. Specifically, the consistency probability calculation unit 4 calculates a joint probability that none of the inference rules that contradict the candidate hypothesis holds true forwardly.

For example, in the candidate hypothesis shown in FIG. 6, the inference rules that contradict the candidate hypotheses corresponds to broken line arrows. In order for the candidate hypotheses to be consistent with the background knowledge D2, it is sufficient that these inference rules do not hold true, and therefore the consistency probability can be calculated as 0.1 by subtracting the probability 0.9 that this rule holds true from 1.0.

Next, in step A5, the solution hypothesis determination unit 5 selects, out of the candidate hypotheses included in the candidate hypothesis set D3, a candidate hypothesis regarding which the probability of holding true as an explanation regarding the query logical formula D1, that is, the evaluation value obtained by multiplying the posterior probability, the deduction probability, and the consistency probability is largest. For example, in the candidate hypothesis shown in FIG. 6, the probability of holding true as an explanation regarding the query logical formula D1 is as shown in formula (10).

0.1×0.81×0.1=0.0081 (10)

Next, in step A6, the output information generation unit 7 acquires the candidate hypothesis, the posterior probability, the deduction probability, and the consistency probability, and generates output information in which the posterior probability, the deduction probability, and the consistency probability are given to the candidate hypothesis, and that is to be output to the output device 8. Alternatively, in step A6, the output information generation unit 7 generates proof tree information for outputting a proof tree structure to the output device 8 using the query logical formula D1, the candidate hypothesis, the posterior probability, the deduction probability, the consistency probability, and the solution hypothesis D4.

Moreover, the output information generation unit 7 may generate both of the output information and the proof tree information. For example, it is conceivable to display the output information and the proof tree information, as shown in FIG. 6. Note that the output information generation unit 7 generates information for displaying a display as shown in FIG. 6 using pieces of information 71, 72, 73, and 74 shown in FIG. 7, for example.

The information 71 is information in which a “node ID” for identifying a logical formula included in the candidate hypothesis is associated with the logical formula, for example. The information 72 is information in which a “rule ID” for identifying an inference rule included in the candidate hypothesis is associated with the inference rule, for example. The information 73 is information in which an edge (solid line arrow shown in FIG. 6) included in the candidate hypothesis is associated with a “start node ID” indicating the start point, an “end point node ID” indicating the end point, and a “rule ID”, for example. The information 74 is information in which a contradiction edge (broken line arrow shown in FIG. 6) included in the candidate hypothesis is associated with a “node ID” indicating the cause of contradiction and a “rule ID” indicating the contradicted rule, for example.

Next, in step A7, the output device 8 receives the output information or proof tree information that has been converted to an outputtable format, or both pieces of the information from the output information generation unit 7, and outputs an image, a sound, and the like that are generated based on the output information or the proof tree information, or both pieces of the information.

### Modified Example 1

Modified Example 1 will be described. In the known Cost-based Probabilistic Abduction, the posterior probability of a candidate hypothesis regarding the query logical formula D1 is calculated as a total sum of negative logarithmic values (costs) of backward probabilities of inference rules used therein, and a candidate regarding which the total sum is smallest is output as the best hypothesis.

In contrast, in Modified Example 1, the cost is a total sum (cost) of the respective negative logarithmic values of the posterior probability, the deduction probability, and the consistency probability. As a result, the cost regarding the candidate hypothesis shown in FIG. 6 can be expressed as formula (11).

cost(H)=−log(0.1)−log(0.81)−log(0.1) (11)

Thereafter, as a result of retrieving a candidate hypothesis regarding which the total sum (cost) is smallest, a candidate hypothesis regarding which the value obtained by multiplying the posterior probability, the deduction probability, and the consistency probability is largest can be derived.

Note that this processing can be replaced by processing for retrieving a candidate hypothesis regarding which an evaluation value is largest, the evaluation value being a total sum of logarithmic values of probabilities. As a result, the evaluation value regarding the candidate hypothesis shown in FIG. 6 can be expressed as formula (11′).

eval(H)=log(0.1)+log(0.81)+log(0.1) (11′)

Also, in Modified Example 1, the procedure for selecting a best hypothesis is expressed as an equivalent combinatorial optimization problem, and the problem is solved by using an external solver, and as a result, the best hypothesis can be derived at a high speed. The reason is that, as a result of adopting a procedure that follows the Cost-based Probabilistic Abduction, the target function in the optimization takes a form of a linear sum, and as a result, the procedure for selecting the solution hypothesis can be formulated as an integer linear planning problem.

### Modified Example 2

An abduction model in which a probability and a reward value are combined will be described as Modified Example 2. In Modified Example 2, as a result of using a value obtained by multiplying all of the reward value, the posterior probability, the deduction probability, and the consistency probability regarding the candidate hypothesis as an evaluation value, an abduction model is realized in which an uncertain inference rule can be handled, and an evaluation index other than the probability can be taken into consideration.

The reward value is a value that can be obtained when candidate hypotheses in the candidate hypothesis set D3 and later-described reward definition information are acquired, and the candidate hypotheses respectively hold true. The reward definition information is a set of pairs (reward definitions) of a reward value and its payment condition, and may be freely defined by a user in accordance with a task.

Note that, regarding the procedure for selecting a best hypothesis in this abduction model as well, as a result of expressing as an equivalent combinatorial optimization problem, the procedure can be processed at a high speed using an external solver. Specifically, the total sum of logarithmic values of the reward value, the posterior probability, the deduction probability, and the consistency probability is regarded as the evaluation value, and a candidate hypothesis regarding which the total sum is largest is retrieved.

### Effects According to Present Example Embodiment

As described above, according to the present example embodiment, the solution hypothesis is determined out of candidate hypotheses based on the posterior probability, the deduction probability, and the consistency probability, and as a result, an uncertain inference rule can be handled.

Also, according to the present example embodiment, as a result of probabilistically generalizing a precondition that is needed to be satisfied by a candidate hypothesis, the probability (deduction probability) that a query logical formula can be deductively derived from a candidate hypothesis and background knowledge and a probability (consistency probability) that the candidate hypothesis does not contradict the background knowledge are considered as evaluation indices. Therefore, an uncertain inference rule and logical constraint can be correctly handled. That is, the uncertainty in an inference rule and a logical constraint can be considered in evaluation.

Also, the posterior probability, the deduction probability, and the consistency probability are separately calculated, and when a solution hypothesis is retrieved, these probabilities need only be multiplied, and therefore if only the calculation formula thereof is retained, the posterior probability, the deduction probability, and the consistency probability can be output along with the corresponding candidate hypothesis.

Also, since being based on the abduction, a proof tree having a graph structure can be output in addition to the logical formula as the inference result. As a result, the posterior probability, the deduction probability, the consistency probability, and the proof tree can be presented to a user.

Note that, with the Etcetera Abduction, although a forward reliability can be handled, P(H) is maximized as a target function, and therefore a specific value of P(H|O) that is originally needed cannot be known. Moreover, the evaluation value in the Etcetera Abduction is calculated based on the reliability regarding the inference rule used in the candidate hypothesis, and therefore the reliability regarding an inference rule that does not hold true in the candidate hypothesis cannot be considered in the evaluation. Therefore, an evaluation cannot be correctly performed with respect to a candidate hypothesis that contradicts a soft constraint, that is, a logical constraint in which a probability of not holding true exists such as a constraint in which if “elephant(x)Λfly(x)” holds true, a contradiction is derived with a probability 0.9.

Also, the MLN-formulated Abduction is based on the MLN (Markov Logic Networks), and therefore a soft inference rule can be handled, but a proof tree cannot be presented.

[Program]

A program according to the present example embodiment need only be a program for causing a computer to perform steps A1 to A7 shown in FIG. 4. The abduction apparatus and the abduction method according to the present example embodiment can be realized by installing this program on a computer and executing the program. In this case, a processor of the computer functions as the candidate hypothesis generation unit 6, the posterior probability calculation unit 2, the deduction probability calculation unit 3, the consistency probability calculation unit 4, the solution hypothesis determination unit 5, and the output information generation unit 7, and performs processing.

Also, the program according to the present example embodiment may also be executed by a computer system that includes a plurality of computers. In this case, for example, each of the computers may function as any of the candidate hypothesis generation unit 6, the posterior probability calculation unit 2, the deduction probability calculation unit 3, the consistency probability calculation unit 4, the solution hypothesis determination unit 5, and the output information generation unit 7.

[Physical Configuration]

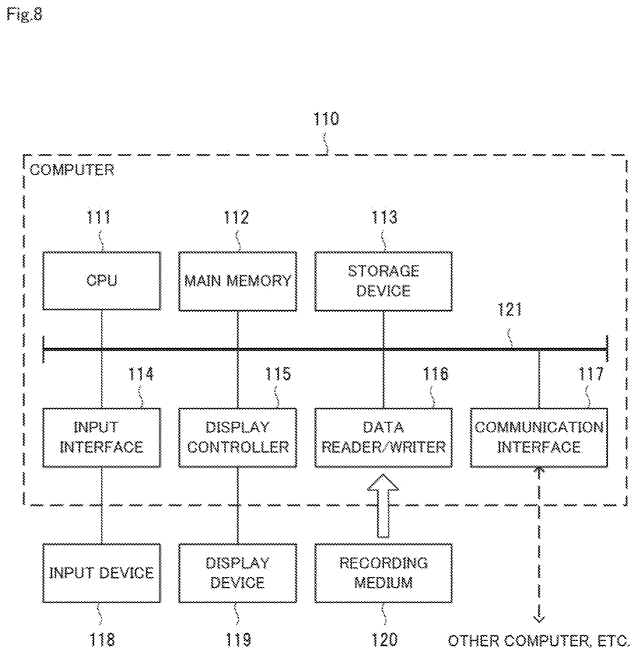

A description will now be given, with reference to FIG. 8, of a computer that realizes the abduction apparatus by executing the program according to the present example embodiment. FIG. 8 is a block diagram illustrating an example of a computer that realizes the abduction apparatus according to the present example embodiment of the present invention.

As shown in FIG. 8, a computer 110 includes a CPU 111, a main memory 112, a storage device 113, an input interface 114, a display controller 115, a data reader/writer 116, and a communication interface 117. These units are connected to each other via a bus 121 so as to be able to communicate data. Note that the computer 110 may also include, in addition to the CPU 111 or in place of the CPU 111, a GPU (Graphics Processing Unit), or an FPGA (Field-Programmable Gate Array).

The CPU 111 loads the program (codes) according to the present example embodiment that is stored in the storage device 113 to the main memory 112 and executes the program in a predetermined order, thereby performing various kinds of computation. The main memory 112 is typically a volatile storage device such as a DRAM (Dynamic Random Access Memory). The program according to the present example embodiment is provided in a state of being stored in a computer-readable recording medium 120. Note that the program according to the present example embodiment may also be distributed on the Internet to which the computer is connected via the communication interface 117.

Specific examples of the storage device 113 may include a hard disk drive, a semiconductor storage device such as a flash memory, and the like. The input interface 114 mediates data transmission between the CPU 111 and input devices 118 such as a keyboard and a mouse. The display controller 115 is connected to a display device 119 and controls a display in the display device 119.

The data reader/writer 116 mediates data transmission between the CPU 111 and the recording medium 120, reads out the program from the recording medium 120, and writes, in the recording medium 120, the results of processing performed by the computer 110. The communication interface 117 mediates data transmission between the CPU 111 and other computers.

Specific examples of the recording medium 120 may include a general-purpose semiconductor storage device such as a CF (Compact Flash (registered trademark)) or an SD (Secure Digital), a magnetic recording medium such as a Flexible Disk, and an optical recording medium such as a CD-ROM (Compact Disk Read Only Memory).

Note that the abduction apparatus 1 according to the present example embodiment may also be realized using hardware that corresponds to each of the units, rather than a computer in which the program is installed. Furthermore, the abduction apparatus 1 may be partially realized by a program, and the remainder may be realized by hardware.

[Supplementary Note]

In relation to the above example embodiment, the following Supplementary Notes are further disclosed. Part of, or the entire present example embodiment described above can be expressed by the following (Supplementary note 1) to (Supplementary note 12), but is not limited thereto.

(Supplementary Note 1)

An abduction apparatus including:
a posterior probability calculation unit configured to calculate, a posterior probability regarding the observation information with respect to each of candidate hypotheses generated using observation information and knowledge information;
a deduction probability calculation unit configured to calculate, a deduction probability of deriving observation information as a consequence of applying the knowledge information with respect to each of the candidate hypotheses;
a consistency probability calculation unit configured to calculate, a consistency probability of not contradicting the knowledge information with respect to each of the candidate hypotheses; and
a solution hypothesis determination unit configured to calculate an evaluation value using the posterior probability, the deduction probability, and the consistency probability, and determine a solution hypothesis that is a best explanation regarding the observation information, from the candidate hypotheses, based on the calculated evaluation value.

(Supplementary Note 2)

The abduction apparatus according to supplementary note 1,
wherein the solution hypothesis determination unit calculates the evaluation value by multiplying the posterior probability, the deduction probability, and the consistency probability, and determines the candidate hypothesis regarding which the evaluation value is largest as the solution hypothesis.

(Supplementary Note 3)

The abduction apparatus according to supplementary note 1 or 2, further including:
an output information generation unit configured to generate output information in which the posterior probability, the deduction probability, and the consistency probability are given to the candidate hypothesis, and that is to be output to an output device.

(Supplementary Note 4)

The abduction apparatus according to supplementary note 3,
wherein the output information generation unit generates proof tree information for outputting a proof tree structure to the output device using the observation information, the candidate hypothesis, the posterior probability, the deduction probability, the consistency probability, and the solution hypothesis.

(Supplementary Note 5)

An abduction method, including:
(a) a step of calculating, a posterior probability regarding the observation information with respect to each of candidate hypotheses generated using observation information and knowledge information;
(b) a step of calculating, a deduction probability of deriving observation information as a consequence of applying the knowledge information with respect to each of the candidate hypotheses;
(c) a step of calculating, a consistency probability of not contradicting the knowledge information with respect to each of the candidate hypotheses; and
(d) a step of calculating an evaluation value using the posterior probability, the deduction probability, and the consistency probability, and determining a solution hypothesis that is a best explanation regarding the observation information, from the candidate hypotheses, based on the calculated evaluation value.

(Supplementary Note 6)

The abduction method according to supplementary note 5,
wherein, in the (d) step, the evaluation value is calculated by multiplying the posterior probability, the deduction probability, and the consistency probability, and the candidate hypothesis regarding which the evaluation value is largest is determined as the solution hypothesis.

(Supplementary Note 7)

The abduction method according to supplementary note 5 or 6, further including:
(e) a step of generating output information in which the posterior probability, the deduction probability, and the consistency probability are given to the candidate hypothesis, and that is to be output to an output device.

(Supplementary Note 8)

The abduction method according to supplementary note 3,
wherein, in the (e) step, proof tree information for outputting a proof tree structure to the output device is generated using the observation information, the candidate hypothesis, the posterior probability, the deduction probability, the consistency probability, and the solution hypothesis.

(Supplementary Note 9)

A computer-readable recording medium that includes a program recorded thereon, the program causing a computer to carry out:
(a) a step of calculating, a posterior probability regarding the observation information with respect to each of candidate hypotheses generated using observation information and knowledge information;
(b) a step of calculating, a deduction probability of deriving observation information as a consequence of applying the knowledge information with respect to each of the candidate hypotheses;
(c) a step of calculating, a consistency probability of not contradicting the knowledge information with respect to each of the candidate hypotheses; and
(d) a step of calculating an evaluation value using the posterior probability, the deduction probability, and the consistency probability, and determining a solution hypothesis that is a best explanation regarding the observation information, from the candidate hypotheses, based on the calculated evaluation value.

(Supplementary Note 10)

The computer readable recording medium that includes the program according to supplementary note 9 recorded thereon,
wherein, in the (d) step, the evaluation value is calculated by multiplying the posterior probability, the deduction probability, and the consistency probability, and the candidate hypothesis regarding which the evaluation value is largest is determined as the solution hypothesis.

(Supplementary Note 11)

The computer readable recording medium that includes the program according to supplementary note 9 or 10 recorded thereon, the program further causing the computer to carry out:
(e) a step of generating output information in which the posterior probability, the deduction probability, and the consistency probability are given to the candidate hypothesis, and that is to be output to an output device.

(Supplementary Note 12)

The computer readable recording medium that includes the program according to supplementary note 11 recorded thereon,
wherein, in the (e) step, proof tree information for outputting a proof tree structure to the output device is generated using the observation information, the candidate hypothesis, the posterior probability, the deduction probability, the consistency probability, and the solution hypothesis.

The present invention of the present application has been described above with reference to the present example embodiment, but the invention of the present application is not limited to the above present example embodiment. The configurations and the details of the invention of the present application may be changed in various manners that can be understood by a person skilled in the art within the scope of the invention of the present application.

### INDUSTRIAL APPLICABILITY

As described above, according to the present invention, an uncertain inference rule can be handled. The present invention is useful in a field in which explanation generation, situation understanding, or the like using a query logical formula and background knowledge is needed. Specifically, the present invention can be applied to a medical system, and an automatic system for performing legal advice, risk detection, or the like.

### REFERENCE SIGNS LIST

1 Abduction apparatus
2 Posterior probability calculation unit
3 Deduction probability calculation unit
4 Consistency probability calculation unit
5 Solution hypothesis determination unit
6 Candidate hypothesis generation unit
7 Output information generation unit
8 Output device
20 Storage device
31 Inference rule retrieval unit
32 Application determination unit
33 Inference rule application unit
D1 Query logical formula
D2 Background knowledge
D3 Candidate hypothesis set
D4 Solution hypothesis
110 Computer
111 CPU
112 Main memory
113 Storage device
114 Input interface
115 Display controller
116 Data reader/writer
117 Communication interface
118 Input devices
119 Display device
120 Recording medium
121 Bus

What is claimed is:

1. An abduction apparatus comprising:
a posterior probability calculation unit configured to calculate, a posterior probability regarding observation information with respect to each of candidate hypotheses generated using the observation information and knowledge information;
a deduction probability calculation unit configured to calculate, a deduction probability of deriving observation information as a consequence of applying the knowledge information with respect to each of the candidate hypotheses;
a consistency probability calculation unit configured to calculate, a consistency probability of not contradicting the knowledge information with respect to each of the candidate hypotheses; and
a solution hypothesis determination unit configured to calculate an evaluation value using the posterior probability, the deduction probability, and the consistency probability, and determine a solution hypothesis that is an explanation regarding the observation information, from the candidate hypotheses, based on the calculated evaluation value.

2. The abduction apparatus according to claim 1,
wherein the solution hypothesis determination unit calculates the evaluation value by multiplying the posterior probability, the deduction probability, and the consistency probability, and determines the candidate hypothesis regarding which the evaluation value is largest as the solution hypothesis.

3. The abduction apparatus according to claim 1, further comprising:
an output information generation unit configured to generate output information in which the posterior probability, the deduction probability, and the consistency probability are given to the candidate hypothesis, and that is to be output to an output device.

4. The abduction apparatus according to claim 3,
wherein the output information generation unit generates proof tree information for outputting a proof tree structure to the output device using the observation information, the candidate hypothesis, the posterior probability, the deduction probability, the consistency probability, and the solution hypothesis.

5. An abduction method, comprising:
calculating, with respect to each of candidate hypotheses generated using observation information and knowledge information, a posterior probability regarding the observation information;
calculating, with respect to each of the candidate hypotheses, a deduction probability of deriving observation information as a consequence of applying the knowledge information;
calculating, with respect to each of the candidate hypotheses, a consistency probability of not contradicting the knowledge information; and
calculating an evaluation value using the posterior probability, the deduction probability, and the consistency probability, and determining a solution hypothesis that is an explanation regarding the observation information, from the candidate hypotheses, based on the calculated evaluation value.

6. The abduction method according to claim 5,
wherein, in the calculating the evaluation value and the determining the solution hypothesis, the evaluation value is calculated by multiplying the posterior probability, the deduction probability, and the consistency probability, and the candidate hypothesis regarding which the evaluation value is largest is determined as the solution hypothesis.

7. The abduction method according to claim 5, further comprising:
generating output information in which the posterior probability, the deduction probability, and the consistency probability are given to the candidate hypothesis, and that is to be output to an output device.

8. The abduction method according to claim 7,
wherein, in the generating, proof tree information for outputting a proof tree structure to the output device is generated using the observation information, the candidate hypothesis, the posterior probability, the deduction probability, the consistency probability, and the solution hypothesis.

9. A non-transitory computer-readable recording medium that includes a program recorded thereon, the program causing a computer to carry out:
calculating, with respect to each of candidate hypotheses generated using observation information and knowledge information, a posterior probability regarding the observation information;
calculating, with respect to each of the candidate hypotheses, a deduction probability of deriving observation information as a consequence of applying the knowledge information;
calculating, with respect to each of the candidate hypotheses, a consistency probability of not contradicting the knowledge information; and
calculating an evaluation value using the posterior probability, the deduction probability, and the consistency probability, and determining a solution hypothesis that is an explanation regarding the observation information, from the candidate hypotheses, based on the calculated evaluation value.

10. The non-transitory computer readable recording medium that includes the program according to claim 9 recorded thereon,
wherein, in the calculating the evaluation value and the determining the solution hypothesis, the evaluation value is calculated by multiplying the posterior probability, the deduction probability, and the consistency probability, and the candidate hypothesis regarding which the evaluation value is largest is determined as the solution hypothesis.

11. The non-transitory computer readable recording medium that includes the program according to claim 9 recorded thereon, the program further causing the computer to carry out:
generating output information in which the posterior probability, the deduction probability, and the consistency probability are given to the candidate hypothesis, and that is to be output to an output device.

12. The non-transitory computer readable recording medium that includes the program according to claim 11 recorded thereon,
wherein, in the generating, proof tree information for outputting a proof tree structure to the output device is generated using the observation information, the candidate hypothesis, the posterior probability, the deduction probability, the consistency probability, and the solution hypothesis.
